(19) United States
(12) Patent Application Publication
(10) Pub. No.: US 2008/0182020 A1
(43) Pub. Date: Jul. 31, 2008

(54) Device and Method For Coating Substrates With Catalytically Active Materials

(76) Inventors: Hans-Jurgen Eberle, Munchen (DE); Olaf Helmer, Kolbermoor (DE); Jorg Spengler, Rosenheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/915,369

(22) PCT Filed: May 24, 2006
(86) PCT No.: PCT/EP2006/005000

§ 371 Date: Nov. 23, 2007

(30) Foreign Application Priority Data
May 25, 2005 (DE) 102005024108.5

(51) Int. Cl. B05D 7/22; B05C 11/02

(52) U.S. Cl. 427/231; 118/55

(57) ABSTRACT

The invention relates to a device and a method for filling a molded article that comprises a plurality of at least partially communicating interior cavities with a liquid phase or for removing the excess of a liquid phase used to coat a molded article comprising interior cavities. The inventive method is characterized in that filling or removal of the excess from the interior cavities is carried out by way of an acceleration process and a subsequent braking process, deceleration being faster than the previous acceleration, with the proviso that the inertial forces caused by deceleration and acting upon the excess liquid phase are higher than the sum of the other opposite forces also acting upon the liquid phase.

The invention relates to a device and a method for manufacturing catalytic converters and their use in the purification of exhaust gases.

The invention relates in particular to a method and a device for manufacturing monolithic and porous catalytic converters by applying a wash coat suspension to a molded article (for example honeycomb body, referred to for short as honeycomb or foamed metal element) which has ducts and/or pores, and to the use of the supported catalytic converters which are obtained in this way in purifying exhaust gases of internal combustion engines.

Monolithic or porous catalytic converters for purifying exhaust gases such as oxidizing CO or hydrocarbons to form CO₂ and water or reducing NOₓ with ammonia or urea to form N₂ and water or decomposing urea or its thermal decomposition product, isocyanic acid, to form ammonia and CO₂, have been known for a long time. As a rule, these catalytic converters are constructed in such a way that a molded article through which ducts or pores pass so as to carry a material which is coated with a metal oxide coating (wash coat), for example composed of Al₂O₃, SiO₂ or TiO₂ which has a large surface, and the metals or metal compounds, for example noble metals or transition metal oxides and if appropriate additional promoter compounds/dopants, are applied to or are already contained in these metal oxide surfaces.

However, there are also applications in which the actual metal oxide coatings alone are catalytically active. A typical application case of this is the hydrolysis of isocyanic acid to form ammonia on honeycombs or porous molded articles which are coated with TiO₂.

The honeycombs are generally composed in their entirety of what is referred to as a honeycomb body which can be composed of a honeycomb outer surface and a carrier which is inserted therein, in particular a partially structured and wound sheet metal foil, or the honeycomb is composed in its entirety of a ceramic molded article. The honeycombs essentially have ducts running through them parallel to the axis of the honeycombs. In further developments, which can also be used according to the invention, the honeycombs have porous duct walls. The porous molded articles are preferably composed of porous metal foams or ceramic foams whose porosity can be adjusted by means of the manufacturing method. The manufacture of such metal foams or ceramic foams is carried out by means of methods which are known to a person skilled in the art.

The ducts which pass through a so-called monolithic carrier (“honeycomb”) can have here an ordered or unordered duct structure. In addition, the ducts which run essentially in parallel can also be connected to one another (so-called open duct structures). In open duct structures, a radial gas distribution is also made possible within the honeycomb body (monolithic carrier). The size of the honeycombs and the dimensioning of the ducts will mainly depend here on the dimensions of the exhaust gas line systems, the composition of the exhaust gas and the respective application (DeNOX, DPF, etc.) and be determined by the required pressure losses and the required dwell times of the exhaust gas in the catalytic converter. In the case of porous metal foams or ceramic foams, the distribution of the pore sizes is an important factor which can be adjusted by means of the manufacturing method.

The so-called cell density, specifically the number of ducts per honeycomb or per honeycomb end face, or in the case of foams the number of pores per volume unit, is likewise dependent on the requirements. As a rule, this number is between 50 and 2000 cpsi (cpsi=cells per square inch), that is to say between 50 and 2000 ducts per inch². In individual cases, or for particular applications, the cell densities can be transgressed in the downward or upper directions. The higher this cell density, the larger the surface area available for the reaction; but in the same way the pressure loss also increases as the cell density increases.

For example materials such as cordierite, steatite, duranite® or silicon carbide or molded articles made of silicon dioxide, aluminum oxides, aluminates or else metals and metal alloys can be used as carrier material for honeycombs made of ceramic molded articles. Using metals and metal alloys permits, in particular, complex-structured honeycomb bodies, for example honeycombs with open duct structures, to be manufactured. Porous molded articles are preferably composed of metals or alloys (“metal foams”), but the abovementioned ceramic materials are also suitable for manufacturing porous molded articles (“ceramic foams”). The geometric shape is not restricted to a single shape as long as there are 2 end faces which are arranged essentially plane-parallel to one another, but cylindrical shapes are typically preferred.

A catalytic converter as described above is generally manufactured by applying a so-called wash coat (WC) to the duct walls (coating) or to the pore walls, followed by drying with subsequent calcination at relatively high temperatures for the purpose of compacting and ultimate surface configuration of the wash coat. The catalytically active components are then usually applied to the wash coat from the aqueous solutions of their precursors by impregnation steps. However, it is also possible to apply the active components or their precursor compounds directly with the coating process.

A molded article can be coated with the inorganic high surface area materials using various methods. As a rule, a suspension of the inorganic carrier oxide is firstly produced in water, if appropriate with the addition of additives such as inorganic binders, tensides, catalytic active components, pore formers, rheological assistants and other additives, and the molded article is filled with this so-called wash coat suspension by means of an immersion, suction or pumping process.

In this context, methods are described which introduce only the quantity of wash coat suspension which is precisely calculated and is to remain in the molded article, and distribute this quantity as uniformly as possible, for example over the duct walls and/or pore walls.

Other methods feed an excessive into the molded article (e.g. flooding of a honeycomb) and carry out a subsequent emptying process with which excess wash coat suspension is discharged. Emptying is often carried out in the form of blowing out with an air stream.

DE 19837731 A1 discloses a plurality of these method variants. The emptying of the excess wash coat from a honeycomb by means of a centrifuge unit is described, for example, in GB 1504060.

WO 2004/022937 describes a method for coating honeycomb bodies by using a vibration system which subjects the honeycomb bodies to be coated to vibrations.

The increasingly strict legal requirements relating to the cleaning of exhaust gases, in particular engine exhaust gases, make it necessary to develop new catalytic converters with significantly higher efficiency rates. In addition to improving the catalytic coating, it is also possible to increase the efficiency of catalytic converters significantly by means of optimized carrier materials.

This includes both increasing the cell density and using so-called complex-structured honeycomb or porous molded articles. Complex-structured honeycomb bodies are understood to be honeycombs whose ducts have elevations or depressions or blades, resulting in the generation of turbulences in the gas stream, which likewise leads to better transportation of materials and thus to higher activity rates. This type of carrier also includes open structures; in open structures, as already described above, the ducts are connected to one another by means of corresponding perforations (holes, pores). As a result, in addition to a vertical direction of flow (parallel to the axis of the duct) a greater or lesser degree of horizontal gas flow (radially with respect to the axes of the honeycombs or of the ducts) is also possible. Likewise, complex structures include porous metal foams owing to the irregular arrangement of the pores. Complex structures can be used to manufacture catalytic converters which at the same time have a mixing effect. In addition, it is, of course, also conceivable to have combinations of purely plane-parallel and complex-structured honeycombs.

Honeycombs and porous molded articles with high cell densities and honeycombs with complex-structured and perforated ducts (open structures) can no longer be coated using the previously known methods without a relatively high degree of expenditure. In particular, the blowing out of the excess wash coat suspension with air is no longer possible with open duct structures or pores.

The reason for this is that the air which is used for the blowing out (blowing out air) will basically take the path of least resistance (path of the lowest loss of pressure). As soon as individual open ducts or pores have arisen between the two end faces of the honeycomb or of the porous molded articles, the blowing out air which is subsequently used is diverted through the holes of the open structures or pores in precisely those ducts which are already opened or pore systems which are connected to one another and the pressure of the blowing out air which is used will generally not be sufficient to blow the wash coat suspension downward from ducts or pores which are still partially filled and in which the wash coat suspension is held by capillary forces. A few ducts or pores or pore systems which have already been completely emptied by blowing out give rise to the described effect so that only a small number of ducts or parts of the ducts can be emptied by blowing out alone.

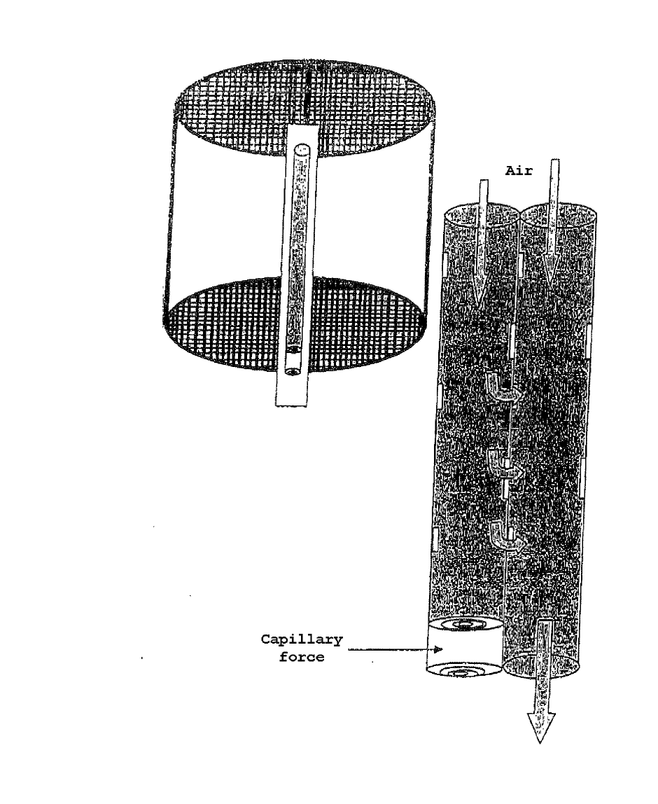

This effect is to be observed in particular with honeycomb with open structures and metal foams is illustrated in FIG. 1: FIG. 1 shows a partial view of two ducts of a honeycomb which run parallel to one another and which are connected by means of a perforation (open structure). While the duct shown on the right has already been cleared of excess wash coat by the blowing out air (the direction of flow of the air is illustrated by the arrows) this is no longer possible in the duct shown on the left for the described reasons so that the residue of wash coat which can no longer be removed by blowing out alone and is held by the capillary force remains in the lower region of the duct. If the air stream is increased to such an extent that all the ducts or parts of the ducts are free, there is then too little wash coat on the carrier.

For this reason, more and more costly methods are necessary to coat complex-structured honeycombs and porous molded articles. Therefore, in DE 10114328 A1 the use of vibrations when applying the wash coat is described. The intention is to improve both the fluidity of the wash coat suspension and to make the application of wash coat as uniform as possible. However, even these methods no longer ensure the complete removal of the excess wash coat suspension which is used since this force is too low to overcome this capillary force.

The object has therefore been to make available a method for coating molded articles (for example honeycombs or sponge foam structures) with interior cavities and/or ducts and open and/or complex cavity structures which the aforesaid problem solves. “Interior cavity” is understood here to be pores, holes, recesses or pores or pore systems which are at least partially continuous with one another. The interior cavities typically pass through the entire molded article.

“Interior cavities” are also understood here to be the open or complex duct systems of honeycombs, such as also pore systems of porous molded articles such as, for example, metal and ceramic foams, which are described above.

In particular, the object has been to make available a method which serves the purpose of clearing or emptying excess wash coat suspension from honeycombs and porous molded articles with open and/or complex structures and which solves the abovementioned problems.

In this context, the solution should be distinguished in particular by measures which are easy to carry out.

It has been surprisingly found that a very good result in terms of the emptying and the separation of excess wash coat suspension in the interior cavities and/or ducts or the molded article to be coated can be achieved if the molded article which is to be emptied coated and the liquid as subjected to a centrifugal force. Centrifugal force is understood to mean the force which acts on a body when it is subjected to acceleration and/or braking processes. A centrifugal force defined according to the invention therefore cannot be generated by vibrations, for example. The body and the liquid contained therein are preferably accelerated and/or braked in such a way that the deceleration which is applied is not larger in absolute value than the absolute value of the previously applied acceleration. The deceleration or the braking of the molded article which is to be emptied or cleared of excess wash coat must therefore be larger, ultimately take place more quickly, than the previously used acceleration. Furthermore, the deceleration must also be of such a magnitude that the force of inertia which occurs in this context is greater than the forces acting between the individual liquid coats of the wash coat, in particular the capillary and friction forces which prevent the excess from flowing out.

Surprisingly it has been found that the layer thickness of the applied wash coat is correlated to the braking force. The weaker the force, the thicker the layer thickness, and the greater the force the thinner, the layer thickness.

According to the inventive method, it is possible, for example, to manufacture monolithic catalytic converters which are based on methal foams or ceramic foams, in particular so-called carrier oxide-based catalytic converters, which can be used, inter alia, as catalytic converters for the purification of exhaust gases.

The principle according to the invention can also be used completely analogously in an inverted form for filling the molded article which is defined above. It is thus possible, for example, to introduce even a highly viscous liquid, through repeated acceleration and subsequent braking, into narrow cavities or ducts of a molded article which are connected at least partially to one another and to the surface of the molded article.

A further object of the invention is therefore a method for filling a liquid phase into a molded article which has a plurality of interior cavities and/or ducts, the filling of the interior cavities being carried out using an acceleration process and a subsequent deceleration (also referred to as a braking process), and wherein the deceleration takes place more quickly than the previously implemented acceleration, with the proviso that the forces of inertia which are caused by the deceleration and act on the liquid phase are greater than the sum of the other oppositely directed forces which also act on the liquid phase.

The principle according to the invention can basically be used with any liquid phase which is located or is to be introduced into the interior cavities, such as ducts and pores, of such a molded article. The liquid phase is usually a wash coat suspension, but the liquid phase can, for example, also comprise solutions or low-viscosity suspensions which are used subsequently to apply catalytically active substances or precursor compounds to a previously coated molded article or carrier body. Carrier bodies, honeycombs, honeycomb bodies and metal foam should be understood below as synonyms or as equivalents of the term “molded article” which is used according to the invention.

The principle according to the invention is preferably used to apply and remove an excess of a wash coat suspension. For this reason, in the text which follows details are given by way of example on, in particular, this configuration of the method according to the invention, which is, however, not to be understood in any way as a restriction since the principle according to the invention can be transferred analogously to all liquid phases.

The principle of the method according to the invention is based on the fact that by virtue of the deceleration an impulse acts on the liquid phase, in particular an excess wash coat suspension, which is located in the ducts and pores, with this impulse having to be larger in absolute value than the sum of the other forces acting upon the liquid phase, in particular the capillary forces and frictional forces.

The effect of the filling and emptying principle according to the invention is not tied here to the specific measure of implementing the acceleration or the braking and deceleration and is in principle completely independent of its specific configuration.

In one embodiment of the method according to the invention, the acceleration can be brought about easily by the force of gravity (for example the free fall of a filled molded article or sliding on an oblique plane) or the acceleration is brought about by a force which acts on the molded article, for example a spring force or a force resulting from a hydraulic device or else a pneumatic device.

The force which occurs during braking (deceleration) is of course greater the faster the braking takes place. The deceleration can take place in the simplest case by means of the impact on a corresponding stationary and fixed brake plate. However, it is also possible for the braking to be brought about by a brake plate which moves counter to the carrier body. In this way, the molded article which is to be emptied is braked even more quickly, which generally leads to an even more improved emptying result. In order to empty the carrier body, the emptying process according to the invention (acceleration and subsequent braking) is repeated several times. The force impulse needed for emptying depends on the condition of the liquid phase, in particular of the wash coat suspension, on the magnitude of the capillary forces which act within the interior cavities such as pores and ducts, and on their dimensioning. The braking force must therefore overcome at least the friction between the liquid layers in order to successfully implement the principle according to the invention.

The absolute value of the deceleration is preferably greater than the absolute value of the acceleration by a factor of ten (10).

In one embodiment of the principle according to the invention, the deceleration can also take place in two separate deceleration phases with (preferably) the absolute value of the deceleration in the first phase being higher than the absolute value of the deceleration in the second phase.

A further important influencing variable is also the temperature. It is thus known that the viscosity of a liquid decreases as the temperature rises, and consequently the forces which act between the liquid layers decrease.

The emptying and filling principle can also be implemented very easily in terms of apparatus by means of mechanical solutions. As a result, the method according to the invention significantly promotes automation of the emptying and filling processes.

A device which is also a subject matter of the present invention and with which the method according to the invention can be carried out comprises means for generating a centrifugal force which acts on the molded article and the liquid phase. The means for generating a centrifugal force are in particular, accelerating and/or braking means.

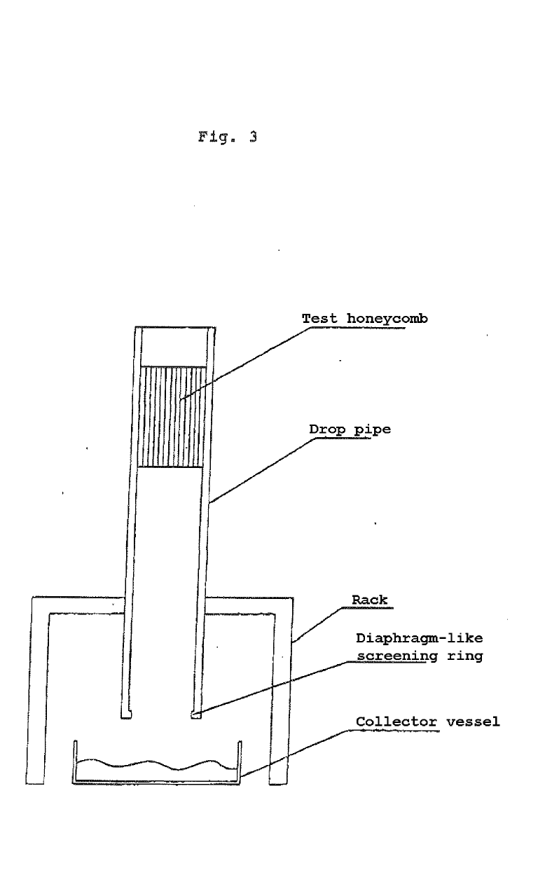

A further device with which the method according to the invention can be carried out is a drop pipe according to FIG. 3. The drop pipe comprises a perpendicularly guided, elongated tubular component in which, for example, the honeycomb from which excess is to be cleared is introduced into the upper region, a rack which is firmly connected to the tubular component, a diaphragm-like screening ring at the lower end of the tubular component which is configured in such a way that the outer wall of the honeycomb (honeycomb sleeve) is supported during the braking process or the honeycomb cannot leave the tubular component through its lower opening (cannot drop through) so that the honeycomb which is to be emptied and accelerated by the free fall is abruptly braked, as well as a collector vessel for the excess liquid phase which flows off. Of course, what has been stated above also applies to the porous molded articles, for example those made of metal foams or ceramic foams.

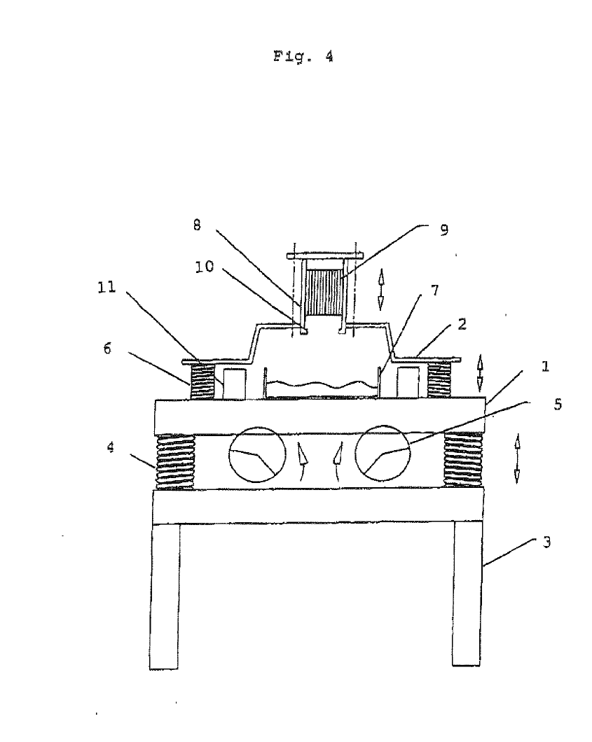

A further device according to the invention, specifically an acceleration impact device with a vibrator according to FIG. 4 is explained by way of example.

In FIG. 4, a molded article having a duct, that is to say for example a monolith or honeycomb, is used. Of course, according to the invention any other molded article described above can likewise be used. The device comprises an oscillating plate (1) which is connected to a rack (3) by means of springs (4), preferably four springs which are mounted on its underside and which are each arranged at the corners of the oscillating plate (1), and said device can be made to oscillate using one or more unbalance motors (5), a second oscillating plate (2) mounted on the top side of the oscillating plate (1), again using springs (6)—preferably again using four springs—in order to amplify the oscillation amplitude, a receiving sleeve (8) which is mounted in the center of the second oscillating plate (2) and has the purpose of receiving the honeycomb body or the honeycomb (9), with the shape of the oscillating plate (2) which is selected, preferably a Z shape, being such that the liquid phase, in particular the wash coat suspension, which runs off during operation of the device flows off into a collector vessel (7) arranged underneath it, and the receiving sleeve (8) is configured in such a way, preferably with a diaphragm-like screening ring (10), that the outer wall of the honeycomb (9) (honeycomb sleeve) is supported during the braking process or the honeycomb (9) cannot leave the receiving sleeve (8) through its lower opening (cannot drop down), a plurality of braking blocks (11), in particular four braking blocks which are arranged next to the springs (6), with the distance of the oscillating plate (2) from the upper edge of the braking block (11) being selected such that it is smaller than the maximum oscillation amplitude (measured without braking blocks) so that during operation of the device the plate (2) always has to “impact” on the brake blocks (11).

With this arrangement it is possible to bring about a relatively large number of acceleration and braking processes within a time period which is appropriate in terms of production technology (seconds-minute range), preferably within 20-200 seconds per monolith or honeycomb.

The honeycomb (9) can be secured here in the receiving sleeve (8) or introduced in a non-secured fashion. If the honeycomb (9) is not secured in the receiving sleeve, an additional (asynchronous) movement of the honeycomb in the receiving sleeve (8) (deflection magnitude up to 10 cm) occurs after the impact on the diaphragm-like screening ring (10). The movement sequence of the honeycomb differs here greatly from that of the oscillation plate since the honeycomb moves down significantly more slowly. As a result, the honeycomb which drops off impacts relatively frequently on an upwardly accelerated oscillating plate (2) or the associated diaphragm-like screening ring (10). The deceleration which acts on the honeycomb in the process and the associated impulse is thus significantly greater than when the honeycomb is secured, as a result of which the emptying effect is amplified.

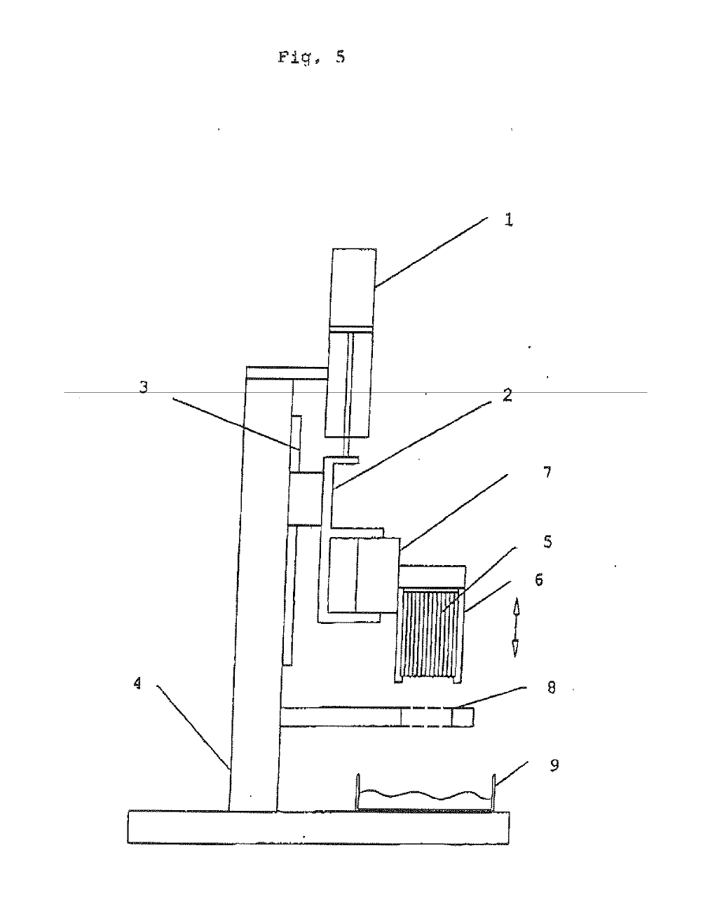

A further device according to the invention with which the method according to the invention can be carried out is a hydraulically or pneumatically operating emptying device according to FIG. 5.

The device according to FIG. 5 comprises a compressed air or hydraulic cylinder (1) to whose piston rod a connecting piece (2) is firmly connected, with the connecting piece (2) being movably connected (upwards/downwards) to a stable rack (4) by means of a guide rail (3), and the connecting piece (2) also being firmly connected to a sleeve mount (7), with a cylindrical receiving sleeve (6) which is open at the bottom and at the top being mounted on the sleeve mount (7) in order to receive the honeycomb or the porous molded article (5), the lower end of said receiving sleeve (6) being configured in such a way, preferably by means of a diaphragm-like screening ring, that the outer wall of the honeycomb (5) (honeycomb sleeve) is supported during the braking process or the honeycomb (9) cannot leave the receiving sleeve (6) through its lower opening (cannot drop down) and an impact plate (8) which is fixed to the rack (4) underneath the receiving sleeve (6), with the impact plate (8) being configured in such a way, in particular by means of an opening, that as a result of the receiving sleeve (6) striking the impact plate (8) the excess liquid phase, in particular wash coat suspension, can flow off downward unimpeded into a collector vessel (9).

The device according to FIG. 5 is suitable in particular for emptying metallic or ceramic foams from metallic honeycomb bodies and porous molded articles.

The method according to the invention for filling a liquid phase into a molded article having interior cavities and/or ducts or for emptying a liquid phase out of such a molded article is based on the fact that the molded article which is filled or partially filled with liquid is firstly accelerated to a speed and then severely braked again so that the force acting on the liquid phase as a result of the deceleration is greater than the sum of the oppositely directed forces acting on the liquid phase, in particular the capillary or frictional forces or those forces which act between the liquid layers of the liquid phase which is located in the ducts.

In a further embodiment, the molded articles can also be filled with the liquid phase, in particular the wash coat suspension, using alternative methods, in particular by means of pumping processes. Furthermore, a first partial emptying process can also take place in accordance with another functional principle, in particular by sucking, blowing out, centrifuging or simply flowing out.

In yet another embodiment, the abovementioned possibilities for partial emptying can also be used in combination with the emptying method according to the invention, in particular in succession or simultaneously.

The inventive principle for removing the excess liquid phase, in particular the wash coat suspension, can in particular be applied as part of a complete coating method of molded articles having ducts or pores.

A further subject matter of the invention is therefore also a method for coating the molded article which has interior cavities and/or ducts at least partially connected to one another and a liquid phase comprising the following steps,
A) the sucking in of a liquid phase through the interior cavities of the molded article to be coated, by applying a partial vacuum to the upper end side of the molded article, while the liquid phase is fed on the lower end side;
B) the partial emptying of the excess liquid phase from the interior cavities and/or ducts of the molded article to be coated by applying an excess pressure to the upper end face of the molded article;
C) removal of the excess liquid phase remaining after step B) from the interior cavities and/or ducts of the molded article to be coated, characterized in that the excess is removed from the interior cavities using an acceleration process and a subsequent deceleration process (braking process), wherein the deceleration takes place more quickly than the previously occurring acceleration, with the proviso that the forces of inertia which are brought about by the deceleration and which acts on the excess liquid phase are greater than the sum of the other oppositely directed forces which also act on the liquid phase.

The liquid phase is preferably a wash coat suspension here.

The excess remaining after step B) can be removed here in step C) preferably with a drop pipe according to FIG. 3 or one of the two devices according to the invention as in FIGS. 4 or 5.

The partial removal of the excess according to step B) can also be applied in combination with any method familiar to a person skilled in the art for emptying molded articles which can be used according to the invention. An air stream (blowing out) which is directed at the ducts or pores and/or centrifugal forces are preferably used.

One possible variant of step B) is that the partial emptying of the molded article occurs exclusively as a result of the flowing out of the excess liquid phase, in particular of the wash coat suspension, due to its own force of gravity and then the emptying of the residue is carried out by the emptying method according to the invention by acceleration and braking.

In one preferred embodiment of the coating method according to the invention, the steps A) and B) are performed repeatedly in succession before step C). In particular, steps A) and B) are each run through three times in order to ensure that all the ducts or pores of the molded article are filled completely at least once with liquid phase, in particular with wash coat suspension.

The filling according to step A) and/or the partial emptying step B) can optionally also be carried out by the effect of vibrations in order to increase the flow properties of the liquid phase or wash coat suspension which is to be sucked in or discharged.

The filling or partial filling of the molded articles with the liquid phase, in particular with the wash coat suspension, can be carried out, for example, with a special device in the form of a piston cylinder system. The device is explained by means of a so-called “honeycomb”, but of course corresponding porous metal foams can also be used.

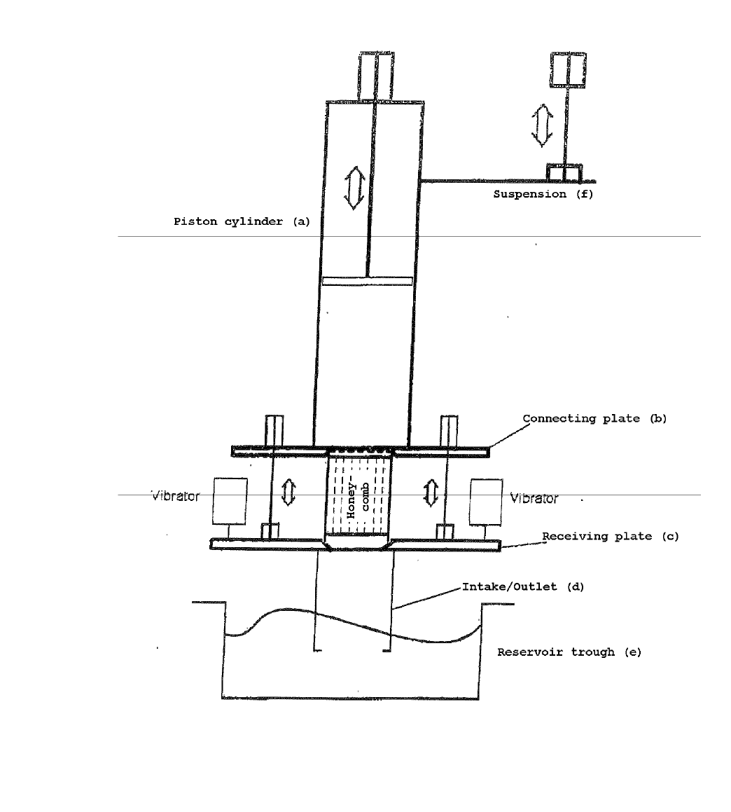

This device according to FIG. 2 comprises a piston cylinder (a) for sucking in or emptying out the wash coat suspension, a connecting plate (b) which is firmly connected to the lower end of the piston cylinder and can be connected in a sealed fashion to the upper end side of the honeycomb to be coated, a receiving plate (c) which can be connected in a seal forming fashion on its upper side to the lower end side of the honeycomb to be coated, optionally one or more vibration units which are attached to the receiving plate (c), a hydraulically movable suspension (f) with which the cylinder unit (a), the connecting plate (b) and the receiving plate (c) can be moved together horizontally (upward and downward movement), an intake/outlet pipe (d) which is mounted on the underside of the receiving plate (c), and a reservoir trough (e) in which the wash coat suspension is stored.

The seal forming connection of the honeycomb to be coated to the connecting plate (b) and the receiving plate (c) is preferably carried out by pressing the end sides of the honeycombs against corresponding, seal forming devices on the plates (b) and (c).

The connecting plate (b) and the receiving plate (c) are each penetrated in the region in which they are to receive the honeycomb to be filled so that, on the one hand, a pressure or partial vacuum can be built up by means of the piston cylinder (a) and, on the other hand, the wash coat suspension can be sucked in or forced out through the intake/outlet pipe (d).

In particular monolithic and catalytic converters which are based on metal foam and on a wash coat which is composed essentially of TiO₂ can be manufactured by the coating method according to the invention or the emptying method according to the invention.

The catalytic converters which can be obtained in accordance with the inventive methods can be used in particular as catalytic converters in the purification of exhaust gases, in particular those from internal combustion engines.

Possible uses of the catalytic converters which can be obtained by means of the method according to the invention are, in particular, the purification of exhaust gases from cars and diesel engines. Furthermore, the catalytic converters which are manufactured according to the inventive method can be used as decomposition catalytic converters for ammonia precursor compounds, as oxidation catalytic converters, as catalytic converters for elimination of nitrogen oxides and as catalytic converters for the reduction of nitrogen oxides.

The method according to the invention can be used, in particular, for manufacturing catalytic converters in which wash coat suspensions, composed of carrier oxides or carrier oxide combinations, selected from the group containing TiO₂, Al₂O₃, SiO₂, CeO₂, ZrO₂ or zeolites are used. The aforesaid carrier oxides or carrier oxide combinations can be doped or coated here in turn with metal oxides. Materials which are already directly catalytically active or which given rise directly to catalytically active coatings can also be used.

The active material preferably contains, as additional components, one or more metal oxide compounds selected from the group containing the oxides of vanadium, tungsten, molybdenum, in particular V₂O₅, WO₃, MoO₃ or noble metal salts, in particular those of palladium, platinum, silver, ruthenium or rhodium.

The catalytically active components can, however, also be applied only in a subsequent step, after the molded article according to the invention which has been coated and emptied has been subjected to temperature treatment.

The wash coat suspension which can be used in the methods according to the invention can contain both inorganic carrier oxides, water, additives and catalytically active components.

The inorganic carrier oxides are preferably selected from the group containing TiO₂, Al₂O₃, SiO₂, CeO₂, ZrO₂ and zeolites.

It is possible to add to the suspensions used in the methods according to the invention inorganic sols or gels, in particular SiO₂, TiO₂, Al₂O₃ sols or gels in order to improve the adhesion of the resulting coating, additives such as organic monomers and polymers, in particular cellulose derivatives or acrylates as pore formers as well as adhesion promoters and/or tensides as Theological assistants.

For the molded articles which are to emptied or coated in accordance with the inventive methods it is suitable, in particular, to use molded articles made of materials selected from the group containing cordierite, silicates, zeolites, silicon dioxide, silicon carbide, aluminum oxide and aluminates or mixtures of these substances as well as metals or metal alloys. Metal carrier structures are particularly preferred.

Metallic carrier bodies are preferred, complex-structured metal carriers and metal foams are particularly preferred.

Furthermore, the carrier structures (honeycombs) can have perforated ducts, in particular if they are metallic carrier bodies (honeycombs).

The metal carriers which are used can be pretreated here by means of a thermal or chemical process in such a way that the adhesion of a layer which is applied later is improved. With the method according to the invention it is also possible to empty molded articles with a high to a very high cell density.

The catalytic converters which are manufactured in this way can also pass through a drying step and subsequent calcinating step. The further application of catalytically active compounds such as, for example, noble metal compounds or further wash coats, is also possible. The catalytic converters which are manufactured in this way are used particularly in gas purification processes, in particular in the purification of car exhaust gases. However, they can also be used in other catalytic processes such as, for example, in the chemical industry or in the generation of power.

The inventive principle of the method can also be used for subsequent application of catalytic substances or precursor compounds which are to be applied in the form of solutions or low viscosity suspensions to a precoated carrier body.

In particular, the method according to the invention can be used to manufacture catalytic converters which are composed of a metallic carrier honeycomb or metal foam or ceramic foam which are coated with a wash coat, the wash coat being composed of a zeolite and/or one or more metal oxides selected from the group containing TiO₂, Al₂O₃, SiO₂, CeO₂, ZrO₂ and also containing as catalytically active components one or more oxides from the group containing vanadium, tungsten, molybdenum, such catalysts being used to reduce nitrogen oxides in the presence of nitrogen-containing reducing agents in the purification of diesel engine exhaust gases.

Furthermore, the method according to the invention can be used to manufacture catalytic converters which are composed of a metallic carrier honeycomb or metal foam or ceramic foam which are coated with a wash coat, the wash coat being composed of one or more metal oxides of the group TiO₂, Al₂O₃, SiO₂, CeO₂, ZrO₂ and zeolites, and these catalytic converters being used to decompose ammonia precursor compounds in the purification of diesel engine exhaust gases.

In addition, the method according to the invention can be used to manufacture catalytic converters which are composed of a metallic carrier honeycomb or metal foam or ceramic foam which are coated with a wash coat, the wash coat being composed of a zeolite and/or a plurality of metal oxides selected from the group containing TiO₂, Al₂O₃, SiO₂, CeO₂, ZrO₂ and also containing as catalytically active components one or more metals or metal compounds of platinum, palladium, rhodium, silver and/or ruthenium, such catalytic converters being used to oxidize or reduce nitrogen oxides in the purification of engine combustion exhaust gases.

Explanation of the figures:

FIG. 1 is an illustration of the air stream (arrows) for blowing out the excess wash coat suspension in open structures. The illustration shows two adjacent ducts which are connected to one another by perforations, as a detail of a honeycomb body. In the case of the perforated ducts, the air stream follows that with the smallest pressure loss, making it impossible in such a case to clear out the residue from all the ducts by blowing alone. The excess wash coat suspension is held in the ducts by the capillary forces.

FIG. 2 is a schematic illustration of a piston cylinder system according to the invention.

FIG. 3 is a schematic illustration of the design of a drop pipe, in particular for carrying out the trials according to FIG. 3.

FIG. 4 is a schematic illustration of the design of an acceleration impact device comprising a vibrator.

FIG. 5 is a schematic illustration of the design of a hydraulically operating emptying device.

The following examples are intended to explain the invention in more detail and are not to be considered as a restriction in any case.

### EXAMPLE 1

### Manufacture of a Typical Wash Coat Suspension

100 g TiO₂ with a BET surface 80 m²/g is introduced into 80 g of water, and subsequently 40 g of an aqueous SiO₂ sol (40% content of SiO₂) are added as a binder and the suspension is then homogenized in a gearwheel colloidal mill. The resulting wash coat suspension has a viscosity of approximately 4100 mpa*s.

### EXAMPLE 2

### General Execution of the First Step of the Filling/Partial Emptying of Wash Coat Suspension Into/From a Metal Honeycomb

### 2.1 Description of the Filling and Partial Emptying System:

The first step for filling as well as partial emptying of the honeycomb bodies have been carried out using a piston cylinder system according to FIG. 2.

The system is composed essentially of a piston cylinder (a) for sucking in or emptying out the wash coat suspension, a connecting plate (b) which is firmly connected to the suction cylinder at the lower end of the intake cylinder and which is dimensioned in its underside in such a way that precise to the upper end side of the honeycomb can be connected in a seal forming fashion to the suction cylinder by pressing on a receiving plate (c). One or more vibration units can optionally be attached on the receiving plate (c). This mounting device (plates (c) and (b)) can be moved up and down hydraulically together with the cylinder unit (a) by means of the suspension (f).

An intake/outlet pipe (d) is attached by flange to the receiving plate (c) whose upper side is configured such that the lower end side of the honeycomb can be received. The test system is completed by a reservoir trough (e) into which the wash coat suspension is filled.

### 2.2 General Execution of the Filling or Partial Emptying of a Honeycomb Body

The wash coat suspension from Example 1 is stored in the reservoir trough (e), specifically in at least such an amount that during the later filling process the intake pipe (d) is always immersed completely in the wash coat suspension. The honeycomb is then inserted in a seal forming fashion into the holding device comprising the plates (b) and (c) by hydraulically pressing on the receiving plate (c) with the honeycomb onto the connecting plate (b), and the piston cylinder unit (a), together with the holding device comprising the plates (b) and (c), is moved downward hydraulically by means of the suspension (f) to such an extent that the immersion pipe (d) dips into the wash coat suspension. The cylinder piston (a) is then moved upward (also hydraulically), as a result of which the wash coat suspension is sucked into the honeycomb via the intake pipe (d). The piston stroke is selected here such that the wash coat suspension is sucked in at least to such an extent that the upper end face of the honeycomb is fully covered. A large part of the excess wash coat suspension is forced into the reservoir trough (e) again through rapid lowering of the piston (a). This process is repeated at least twice, ensuring that all the ducts have been completely filled (flooded) at least once.

In order to fill/empty the honeycomb better, the vibrator which is attached to the receiving plate (c) is activated during the entire process (compressed air vibrator from Netter, NFP 18s, rated frequency 7700 min⁻¹ at 6bar, centrifugal force 128 N at 6 bar) in order to additionally improve the flowing properties of the wash coat suspension by applying a vibration frequency.

After at least three pumping-in and expelling processes, the piston is held at the bottom after the last expelling process for at least one minute, and remains at the bottom. The cylinder piston (a), together with the holding device comprising the plates (b) and (c), is then moved upward again pneumatically by means of the suspension (f), in which case, finally, the run-out pipe (d) no longer dips into the wash coat suspension. The honeycomb can be removed for further processing (emptying of residue) after corresponding relief of pressure (depressurization of the hydraulics for the holding device).

### COMPARATIVE EXAMPLE 3

### Coating of a Metallic Carrier Body (Honeycomb) With a Mixer Function Using a Vibration Unit and Emptying of the Residue With an Air Stream

A complex-structured metal honeycomb with mixer function (Emitec, type: MI) with a length of 7.5 cm, a diameter of 7 cm and a cell density of 200 cpsi is pretreated thermally for four hours in a calcinating furnace under an air atmosphere. The honeycomb which is cooled to room temperature is then filled by means of the procedure described under Example 2.2 with a wash coat suspension which is manufactured according to Example 1, and partially emptied. The test honeycomb is then removed and the proportion of wash coat suspension which is contained is determined by weighing. 160 g of wash coat suspension is located in the carrier honeycomb.

Immediately after this, an air stream (approximately 200 m³/h) is blown through (blowing out) for emptying the honeycomb for the duration of 1 min, and the quantity of wash coat suspension which has remained in the honeycomb is determined again by weighing. After the blowing out, 140 g of wash coat suspension is still located in the honeycomb. As a result, only a small proportion (20 g) of the excess wash coat suspension which has remained in the ducts can be driven out again by blowing out.

### EXAMPLE 4

### Coating of a Metallic Carrier Body With Mixer Function Using a Vibration Unit and Subsequent Emptying of the Residue in a Drop Pipe

The trial described in Example 3 is repeated with the difference that in order to empty the residue the partially emptied honeycomb according to Example 2.2 which has been removed from the piston cylinder machine (mass of the wash coat suspension contained in the honeycomb=161 g) is allowed to drop in a 1 m long drop pipe in free fall onto a impact shutter (according to FIG. 3). Due to the rapid braking process (impact), further emptying of the residue of excess wash coat suspension from the honeycomb occurs. This process was repeated 9× (nine times); the results are represented in Table 1.

TABLE 1
The residual quantity of remaining wash coat suspension in the honeycomb
as a function of the number of impact tests with the drop pipe
(at beginning: 161 g wash coat suspension in the honeycomb)
Impact sequence

| | Number of impacts | | | | | | | | | |
|---|---|---|---|---|---|---|---|---|---|---|
| | 1 | 2 | 3 | 4 | 5 | 6 | 7 | 8 | 9 | 10 |
| Mass of wash | 146 | 133 | 124 | 116 | 109 | 103 | 99 | 95 | 91 | 89 |
| coat in | | | | | | | | | | |
| honeycomb in g | | | | | | | | | | |

From the results it becomes clear that appreciable emptying of the residue can occur solely through this simple method variant of acceleration (free fall from 1 m height) and rapid braking (impact on a receiving plate), in particular a plurality of drop impact tests are carried out in succession. After 10 (ten) successive drop impact tests the residual quantity of 161 g reduces to 89 g.

### EXAMPLE 5

### Coating of a Metallic Carrier Body With Mixer Function Using a Vibration Unit and Subsequent Emptying of the Residue in an Acceleration Impact Machine (Vibrator)

### 5.1 Description of the Emptying Apparatus

The equipment according to FIG. 4 comprises a large oscillating plate (1) which is connected to a rack (3) by means of four springs (4) which are respectively arranged at the corners, and is made to oscillate using one or more unbalanced motors (5). A further oscillating plate (2) is attached to the upper side of the oscillating plate (1) by means of a further four springs (6). The sense of this arrangement is to amplify the oscillation amplitude. In the center of the oscillating plate (2) a receiving sleeve (8) is mounted for receiving the test honeycomb (9). The shape of the oscillating plate (2) which is selected (Z shape) is such that the wash coat suspension which runs off during operation of the machine can be collected in a collector vessel (7) arranged underneath it. The receiving sleeve (8) is configured at the lower end (diaphragm-like screening ring 10) in such a way that the outer wall of the test honeycomb (9) is supported during the braking process or the honeycomb cannot drop through. The requested braking process is brought about by means of four braking blocks (11) which, according to the sketch, are arranged next to the springs (6). The distance of the oscillating plate (2) from the braking blocks has to be smaller here than the maximum oscillating amplitude (measured without braking blocks) so that an “impact” of the plate (2) on the brake blocks (11) must always occur. With this arrangement it is possible to bring about a relatively large number of acceleration processes and braking processes within an appropriate time period in terms of production technology (seconds-minute range).

### 5.2 Execution of the Test

The test described in the comparative Example 3 is repeated, with the difference that the test honeycomb with a content of 170 g of wash coat suspension is clamped tight into the “emptying machine” (vibrator) described above under 5.1, in order to empty the residue. The oscillating plates (1) and (2) are made to oscillate correspondingly by the activation of unbalanced motors (5) (rotation speed 1600 rpm, unbalance 35%). The distance between the oscillating plate (2) and the brake blocks is 3 mm in the stationary state. The oscillation amplitude of the oscillating plate (2) is approximately 15 mm under these conditions.

After a test period of 45 sec, the honeycomb is removed from the receiving device and weighed.

After the 45 sec, only 84 g of wash coat suspension is still present in the honeycomb. The honeycomb is then dried in a drying cabinet at 150° C. and subsequently calcinated for 4 hours at 450° C. The quantity of “dried wash coat” is 44 g, which corresponds to a wash coat quantity (dry weight), referred to the volume of the honeycomb, of 153 g/l honeycomb.

### EXAMPLE 6

### Coating of a Metallic Carrier Body With a Mixer Function Using a Vibration Unit and Subsequent Emptying of the Residue in an Acceleration Impact Machine (Vibrator) With an Unsecured Honeycomb

The test described in Example 5.2 is repeated, with the difference that the test honeycomb with a wash coat suspension content of 168 g is introduced into the receiving sleeve (8) but in this case the honeycomb is not firmly secured.

The failure to secure the honeycomb means that an additional movement of the honeycomb occurs in the sleeve (deflection distance up to 5 cm) after the impact on the diaphragm-like screening ring (10)). The movement sequence of the honeycomb differs here greatly from that of the oscillating plate (the honeycomb moves downward substantially more slowly). As a result, the falling honeycomb impacts relatively frequently on an upwardly accelerated oscillating plate (2) or the impact surface (diaphragm-like screening ring (10)) which is connected to it. The deceleration which acts on the honeycomb in this context and the associated impulse is therefore significantly higher than in the example 5.2, as a result of which the emptying effect is amplified.

With the same setting of the parameters as in Example 5.2, the test is ended after 45 sec and the honeycomb weighed. Only 40 g of WC suspension was still present in the honeycomb. This shows that by decoupling the movement of the receiving plate and honeycomb (=upward movement of the plate and downward movement of the honeycomb), the braking pulse which results when an impact occurs is significantly increased and in this way very effective emptying of the residue in the honeycomb can be brought about.

### EXAMPLE 7

### Emptying of the Residue of a Metallic Honeycomb Body Which is Filled With Wash Coat Suspension With a Hydraulically Operating Emptying Device According to the Impact Principle

### 7.1 Hydraulically Operating Emptying Device

The device according to FIG. 5 is particularly suitable for emptying honeycomb bodies made of metal.

The equipment according to FIG. 5 comprises a compressed air/hydraulic cylinder (1) to whose piston rod a connecting piece (2) is firmly connected. This connecting piece is movably connected (up/down) to a stable rack by means of a guide rail (3). In order to receive the test honeycomb, a cylindrical receiving sleeve (6) which is open at the bottom and at the top is used, the lower end of said receiving sleeve (6) being configured in such a way (diaphragm-like screening ring) that the outer wall of the test honeycomb (5) is supported or the honeycomb cannot drop through. The receiving sleeve (6) is in turn firmly connected to the connecting piece (2) by means of the sleeve mount (7). A receiving plate (8) is also connected to the rack (4) underneath the receiving sleeve (6). The impact plate (8) is configured here in such a way that the receiving sleeve can impact on its upper side, triggered by a downward movement, and in the process the wash coat suspension can run down unimpeded into a collector vessel (9).

1. Method filling a molded article (9) with a liquid phase and for removing a liquid phase from a molded article (9), wherein the molded article (9) has a plurality of interior cavities and/or ducts, characterized in that the device has means for generating a centrifugal force which acts on the molded article (9) and the liquid phase.

2. The device as claimed in claim 1, characterized in that the means for generating a centrifugal force are accelerating means and/or braking means.

3. The device as claimed in claim 1, characterized in that the accelerating means comprise a first oscillating plate (1) which is connected via springs (4) mounted on its underside to a rack (3), and a second oscillating plate (2) which is mounted on the upper side of the first oscillating plate (1) via springs (6) in order to amplify the oscillation amplitude of the first oscillating plate (1), and wherein the braking means comprise a receiving sleeve (8) which is mounted in the center of the second oscillating plate (2) and has the purpose of receiving the molded article (9).

4. The device as claimed in claim 3, further comprising a multiplicity of braking blocks (11) which are arranged next to the springs (6), wherein the distance of the oscillating plate (2) from the upper end of the braking blocks (11) is selected such that this is smaller than the maximum combined oscillation amplitude of the oscillating plates (1), (2).

5. The device as claimed in claim 4, characterized in that each of the springs (4) mounted on the underside of the oscillating plate (1) is arranged at in each case one corner of the oscillating plate (1).

6. The device as claimed in claim 4, characterized in that the oscillating plate (2) has a Z shape.

7. The device as claimed in claim 1, characterized in that the receiving sleeve (8) is provided with a diaphragm like screening ring (10).

8. The device as claimed in claim 1, wherein the accelerating means comprise a compressed air or hydraulic cylinder (1) to whose piston rod a connecting piece (2) is firmly connected, wherein the connecting piece (2) is movably connected via a guide rail (3) to a stable frame (4) and the connecting piece (2) is also firmly connected to a sleeve mount (7), wherein a cylindrical receiving sleeve (6) which is open at the bottom and at the top is mounted on the sleeve mount (7) in order to receive the molded article (5), the lower end of said receiving sleeve (6) being configured in such a way that during a braking process the outer wall of the molded article (5) cannot leave the receiving sleeve (6) through its lower opening and the braking means is an impact plate (8) which is attached to the rack (4) underneath the receiving sleeve (6).

9. A method for filling a molded article with a liquid phase or for removing an excess of a liquid phase, wherein the molded article has a plurality of interior cavities and/or ducts, comprising the step of allowing a centrifugal force to act on the molded article which is filled with the liquid phase in a first step and the liquid phase, wherein the acting centrifugal force is greater than the sum of the other oppositely directed forces which likewise act on the liquid phase.

10. The method as claimed in claim 9, wherein the centrifugal force is a force which is caused by accelerating and/or braking the molded article and the liquid phase.

11. The method as claimed in claim 10, wherein the filled molded article is accelerated to a speed of at least 0.5 m/s and then abruptly braked to the state of rest.

12. The method as claimed in claim 1, wherein the first step of filling comprises:
A) the sucking in of a liquid phase through the interior cavities and/or ducts of the molded article to be coated, by applying a partial vacuum to the upper end side of the molded article, while the liquid phase is fed on the lower end side;
B) the partial emptying of the excess liquid phase from the interior cavities and/or ducts of the molded article by applying an excess pressure to the upper end face of the molded article.

13. The method as claimed in claim 1, characterized in that the liquid phase is a suspension, solution, slurry or dispersion.
